(19) United States
(12) Patent Application Publication
(10) Pub. No.: US 2004/0068598 A1
(43) Pub. Date: Apr. 8, 2004

(54) Multiprocessor system having interrupt controller

(75) Inventor: Mamoru Sakugawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/436,056

(22) Filed: May 13, 2003

(30) Foreign Application Priority Data
Oct. 7, 2002 (JP) 2002-293595

(51) Int. Cl. G06F 13/24

(52) U.S. Cl. 710/260

(57) ABSTRACT

The present invention is to obtain a multiprocessor system which enables appropriately an avoidance of a wrong acceptance by a simple formation of a hardware.

A comparator (30) and a mask register (31) are added between a priority order decision part (23) and an output parts (24₁ and 24₂). When a processor (2₁) accepts an interrupt signal (T₁), the processor (2₁) starts the action of the interrupt handling routine and changes the value of the mask register (31) into a maximum value (a value of the highest priority order). Hereby, the interrupt signal (U) is cancelled. Thus, the interrupt flag signal (Ua) and the interrupt level signal (Ub) are cleared. According to this, the interrupt signals (T₁ and T₂) are also cleared.

### BACKGROUND OF THE INVENTION

1. Field of the Invention

The present invention relates to a multiprocessor system, and more particularly, it relates to a multiprocessor system corresponding to an interrupt controller.

2. Description of the Background Art

FIG. 7 is a block diagram showing a structure of a conventional formation of a multiprocessor system. The multiprocessor system includes plural processors 101₁ to 101ₙ (n is a whole number, at least two), a CPU bus 105, an interrupt bus 106 and an interrupt controller 104. Each of the processors 101₁ to 101ₙ includes CPU cores 102₁ to 102ₙ and interrupt controllers 103₁ to 103ₙ, respectively.

Interrupt requests S₁ to Sₘ (m is a whole number, at least two) which is generated from peripheral I/O devices (not shown in FIG. 7) are inputted to the interrupt controller 104. The interrupt controller 104 sends out the interrupt requests S₁ to Sₘ which is packeted to the interrupt bus 106 after a processing such as a decision of an interrupt priority order, a packet generation and so on. The interrupt controllers 103₁ to 103ₙ monitor packets which flow on the interrupt bus 106, and when packets directing to themselves are in existence, then the interrupt controllers 103₁ to 103ₙ take in the packets from the interrupt bus 106. Afterwards, an interrupt handling is performed by the CPU cores 102₁ to 102ₙ.

Moreover, when arbitrary CPU cores 102₁ to 102ₙ generate the interrupt request for a data communication and so on between the processors 101₁ to 101ₙ, corresponding interrupt controller 103₁ to 103ₙ, generate the packets and send it out to the interrupt bus 106. Afterwards, in the same manner as to the above description, the interrupt handling is performed by the CPU cores 102₁ to 102ₙ after the packets are took in by one of the interrupt controllers 103₁ to 103ₙ.

Besides, a technique corresponding with the multiprocessor system having the interrupt controller is described in the following patent document.

Japanese Patent Application Laid-Open No. 8-55038 (1996).

In case of the interrupt handling in the multiprocessor system, an abuse exists that after an interrupt request is accepted by a certain processor, the same interrupt request is again accepted by the other processors, that is to say, an abuse of a wrong acceptance. In order to prevent the very abuse, regarding to a conventional multiprocessor system, a method to add a programmable timer in order to mask a wrong period is applied (refer to Japanese Patent Application Laid-Open No. 8-50038 (1996)), and thus a problem arises that a formation and an action of the system become complicated.

### SUMMARY OF THE INVETION

The present invention is to obtain a multiprocessor system which enables appropriately an avoidance of a wrong acceptance by a simple formation of a hardware without a complicated interposition of a software.

According to the present invention, a multiprocessor system includes plural processors and an interrupt controller which is connected with the plural processors. In case that an interrupt request is inputted in the interrupt controller, the interrupt controller inputs an interrupt signal to the plural processors. If the interrupt request is accepted by one of the plural processors, a processor which accepts the interrupt request makes the interrupt controller cancel the interrupt signal.

A situation can be avoided that after an interrupt request is accepted by a certain processor, the same interrupt request is again accepted by the other processors.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a formation of a multiprocessor system according to a preferred embodiment 1 of the present invention.

FIG. 2 is a block diagram illustrating a concrete formation of the interrupt controller which is a premise of the present invention.

FIG. 3 is a timing chart for describing an action of the interrupt controller shown in FIG. 2.

FIG. 4 is a block diagram illustrating a concrete formation of the interrupt controller according to the preferred embodiment 1 of the present invention.

FIG. 5 is a timing chart for describing an action of the interrupt controller according to the preferred embodiment 1 of the present invention.

FIG. 6 is a timing chart for describing an action of the interrupt controller according to a preferred embodiment 2 of the present invention.

FIG. 7 is a block diagram illustrating a conventional formation of a multiprocessor system.

### DESCRIPTION OF THE PREFERRED EMBODIMENTS

Preferred Embodiment 1.

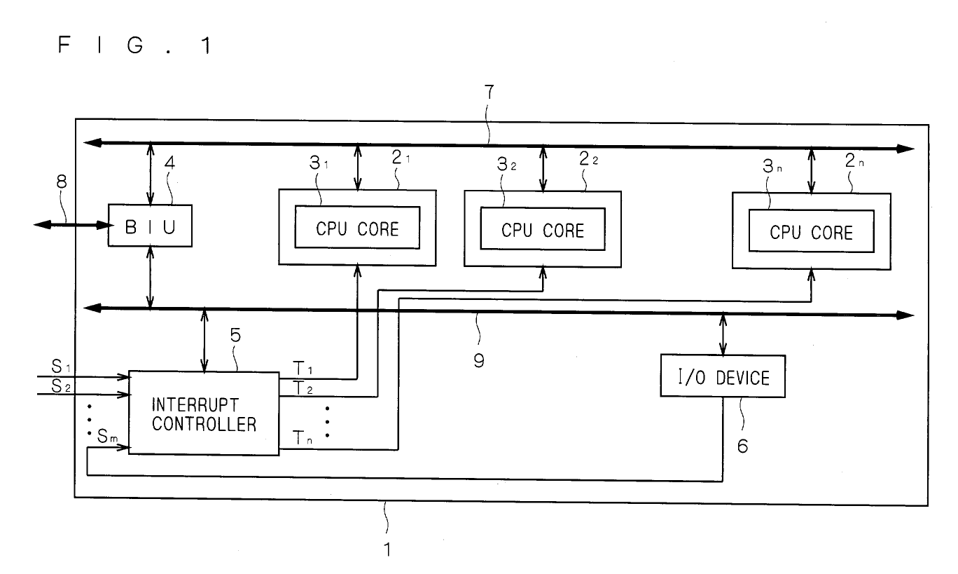

FIG. 1 is a block diagram illustrating a formation of a multiprocessor system according to the preferred embodiment 1 of the present invention. An LSI 1 includes plural processors 2₁ to 2ₙ, a bus interface unit (BIU) 4, an interrupt controller 5, an I/O device 6 which is a timer, a serial I/O or the like, a CPU bus 7, an outside bus 8 which a device such as a memory and so on (not shown in FIG. 1) is connected with and an I/O bus 9. Each of the processors 2₁ to 2ₙ has CPU cores 3₁ to 3ₙ and a cash memory (not shown in FIG. 1), respectively.

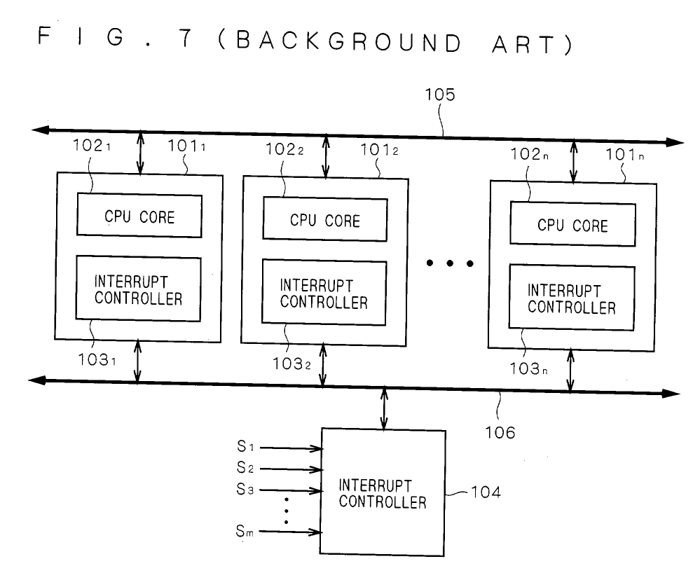

The processors 2₁ to 2ₙ and the BIU 4 are connected with the CPU bus 7. The BIU 4, the interrupt controller 5 and the I/O device 6 are connected with the I/O bus 9. The BIU 4 is connected with the outside bus 8. The interrupt controller 5 is connected directly with each of the processors 2₁ to 2ₙ without an interrupt bus 106 which is shown in FIG. 7 as a medium.

The BIU 4 mediates a command, a data and so on which flow on the CPU bus 7 and controls the outside bus 8 and the I/O bus 9. The processors 2₁ to 2ₙ, in case that a command or a data which is needed does not exist in the cash memory of their own, send out a request for the command or the data to the CPU bus 7. The BIU 4 mediates the request described above from the processors 2₁ to 2ₙ through the CPU 7. An access request from the processor 2₁ to 2ₙ to the interrupt controller 5 and the I/O device 6 is inputted to the interrupt controller 5 and the I/O device 6 through the I/O bus 9 after being mediated by the BIU 4.

The interrupt requests S₁ to Sₘ which are generated by the I/O device 6 which is built-in the LSI 1 or an I/O device (not shown in FIG. 1) which is connected with an outside of the LSI 1 is inputted to the interrupt controller 5. The interrupt controller 5 generates interrupt signals T₁ to Tₙ which are corresponding with each of the processors 2₁ to 2ₙ. The interrupt signals T₁ to Tₙ are inputted directly to each of the processors 2₁ to 2ₙ without the interrupt bus 106 which is shown in FIG. 7 as the medium.

The present invention particularly relates to a formation of the interrupt controller 5, however, before describing the interrupt controller 5 concerning with the present invention, a formation of an interrupt controller which is a premise of the present invention is described at first.

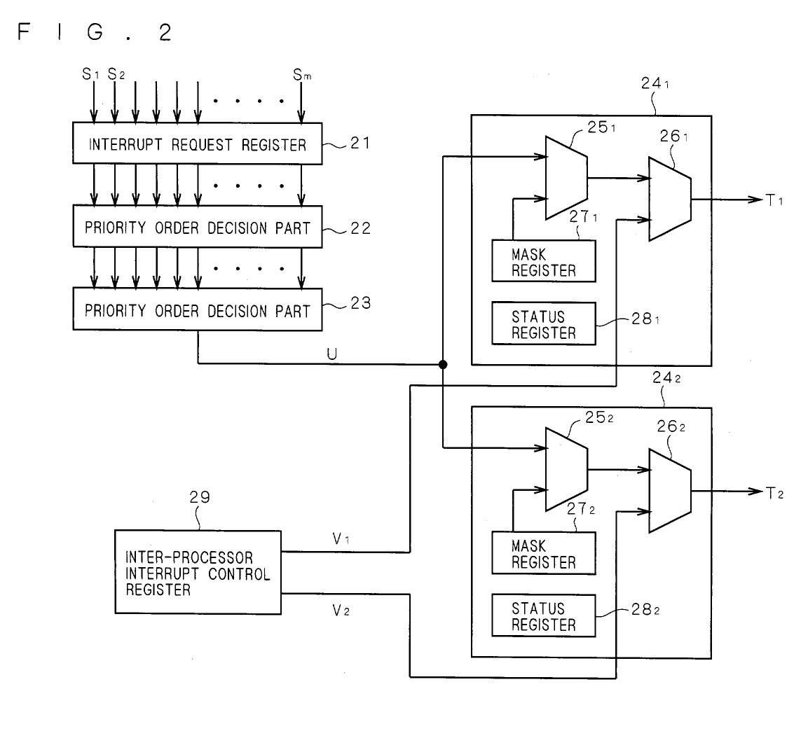

FIG. 2 is a block diagram illustrating a concrete formation of the interrupt controller which is a premise of the present invention. However, for the purpose of a simplification of the drawing, the formation of the interrupt controller is illustrated on the assumption of a multiprocessor system which includes merely two processors 2₁ and 2₂ in FIG. 2. The interrupt controller includes an interrupt request register 21, a priority order decision part 22 based on the interrupt priority order (a priority level), an interrupt priority order decision part 23 based on a formation of a fixed hardware, output parts 24₁ and 24₂ respectively corresponding with the processors 2₁ to 2₂ and an inter-processor interrupt control register 29. The output part 24₁ includes comparators 25₁ and 26₁, a mask register 27₁ and a status register 28₁. In the same manner, the output part 24₂ includes comparators 25₂ and 26₂, a mask register 27₂ and a status register 28₂. The interrupt request register 21, the mask registers 27₁ and 27₂, the status registers 28₁ and 28₂ and the inter-processor interrupt control register 29 are connected with the I/O bus 9 shown in FIG. 1, and the processors 2₁ to 2₂, enable to perform the read-out and the write-in of memory contents of each register.

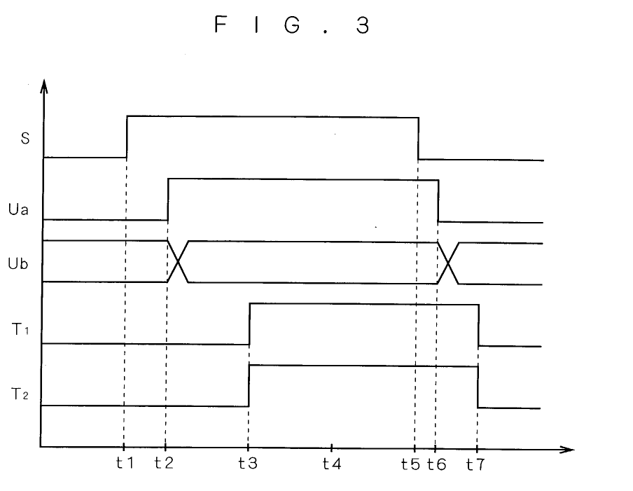

FIG. 3 is a timing chart for describing an action of the interrupt controller shown in FIG. 2. Referring to FIGS. 1 to 3, an action of the interrupt controller which is the premise of the present invention is described thereinafter.

At a time t1, the interrupt requests S₁ to Sₘ (“S” in FIG. 3) which are generated by the I/O device 6 which is built-in the LSI 1 or the I/O device which is connected with the outside of the LSI 1 are inputted to the interrupt request register 21. The interrupt request register 21 exists in every interrupt factor, and sets up a permission or non-permission of the acceptance of the interrupt requests S₁ to Sₘ (that is, setting up a permission bit), an interrupt sense mode and a priority order in each of the interrupt requests S₁ to Sₘ. When the permission bit is set up as “permission”, the interrupt request register 21 detects the interrupt requests S₁ to Sₘ according to an interrupt sense mode. On the other hand, when the permission bit is set up as “non-permission”, the interrupt request register 21 does not detect the interrupt requests S₁ to Sₘ. Here, the permission bit is assumed to be set up as “permission”.

The interrupt requests S₁ to Sₘ which are detected by the interrupt request register 21 are inputted to the priority order decision part 22. The priority order decision part 22 compares each priority order for the interrupt requests S₁ to Sₘ with the others, and specifies one or some of the interrupt requests S₁ to Sₘ of a highest priority order.

One or some of the interrupt requests S₁ to Sₘ which are specified by the priority order decision part 22 are inputted to the priority order decision part 23. The priority order decision part 23 selects one interrupt request from the interrupt requests S₁ to Sₘ whose priority order are equal based on the formation of the fixed hardware. At the time t2, an interrupt signal U corresponding with the selected interrupt requests S₁ to Sₘ, that is an interrupt flag signal (“Ua” in FIG. 3) and an interrupt level signal (“Ub” in FIG. 3) concretely, are outputted from the priority order decision part 23.

The interrupt signal U is inputted to all of the output parts 24₁ and 24₂ in the interrupt controller. The status registers 28₁ and 28₂ retain an interrupt factor number and the priority order of the inputted interrupt signal U. Besides, the comparators 25₁ and 25₂ compare the priority order which is described in the interrupt level signal Ub with the priority order which is set up in the mask registers 27₁ and 27₂. In case that the priority order which is described in the interrupt level signal Ub is higher than the priority order which is set up in the mask registers 27₁ and 27₂, the interrupt signal U is not masked but inputted to the comparators 26₁ and 26₂ of the latter part. Here, the interrupt signal U is assumed not to be masked.

The inter-processor interrupt control register 29 is a register which controls the interrupt between the processors 2₁ and 2₂. By performing to write in the inter-processor interrupt control register 29, inter-processor interrupt requests V₁ and V₂ are inputted to the arbitrary processors 2₁ and 2₂.

In case that the inter-processor interrupt requests V₁ and V₂ are inputted from the inter-processor interrupt control register 29, the comparators 26₁ and 26₂ output the inter-processor interrupt requests V₁ and V₂ without condition. On the other hand, in case that the inter-processor interrupt requests V₁ and V₂ are not inputted from the inter-processor interrupt control register 29, the comparators 26₁ and 26₂ output the interrupt signal U which is inputted from the comparators 25₁ and 25₂ as the interrupt signals T₁ and T₂. Here, at a time t3, the interrupt signals T₁ and T₂ are assumed to be outputted from the comparators 26₁ and 26₂, respectively.

The interrupt signals T₁ and T₂ are inputted to the processors 2₁ and 2₂ respectively. Here, at a time t4, the processor 2₁ is assumed to accept the interrupt signal Tthe earliest. The processor 2₁ starts performing an interrupt handling routine and in the process of performing the interrupt handling routine (a time t5), clears the interrupt request S. According to the condition that the interrupt request S is cleared, the interrupt flag signal Ua and the interrupt level signal Ub are cleared at a time t6, and the interrupt signals T₁ and T₂ are cleared at a time t7.

However, according to the interrupt controller which is the premise of the present invention described above, there is a possibility that the processor 2₂ accepts the interrupt signal T₂ between the time t4 when the interrupt signal Tis accepted by the processor 2₁ and the time t7 when the interrupt signal T₂ is cleared. In this case, a problem arises that the plural processors 2₁ to 2₂ perform the interrupt handling corresponding with one interrupt signal U. The interrupt controller 5 concerning with the present invention in which the problem described above is solved is described hereinafter.

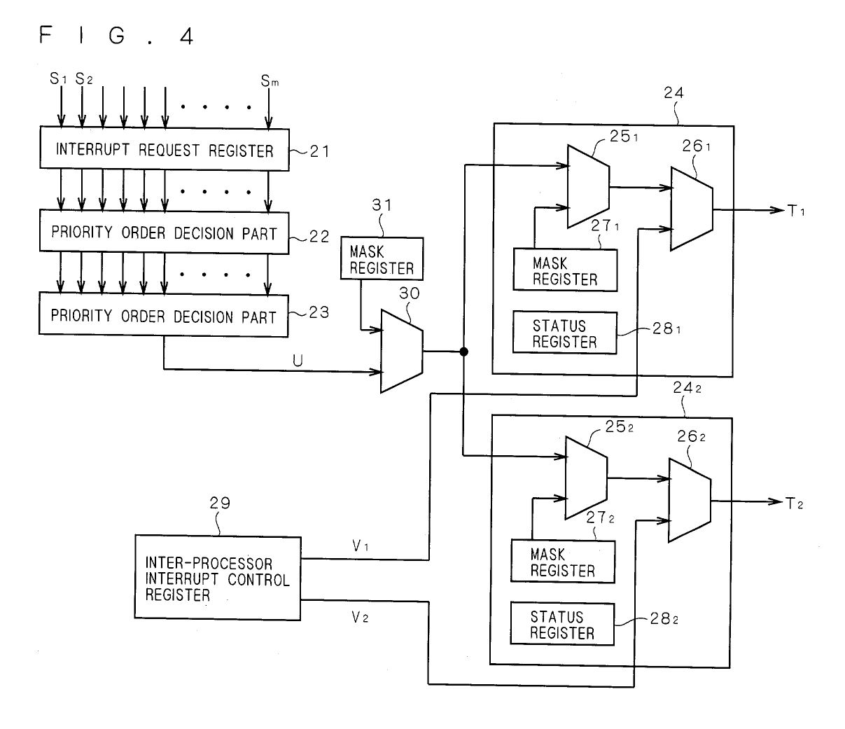

FIG. 4 is a block diagram illustrating a concrete formation of the interrupt controller 5 according to the preferred embodiment 1 of the present invention corresponding with FIG. 2. A comparator 30 and a mask register 31 are added between the priority order decision part 23 and the output parts 24₁ and 24₂. An interrupt priority order is set up in the mask register 31. The priority order which is set up in the mask register 31 can be changed by the processors 2₁ to 2ₙ.

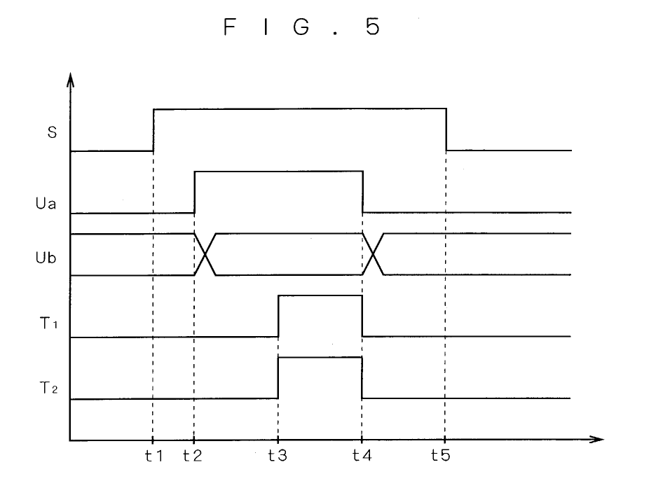

FIG. 5 is a timing chart for describing an action of the interrupt controller 5. Referring to FIGS. 1, 4 and 5, the action of the interrupt controller 5 is described hereinafter.

In the same manner as the above description, at the time t1, the interrupt request S is inputted to the interrupt request register 21. Then, after the decision of the priority order is performed by the priority order decision parts 22 and 23, at the time t2, the interrupt signal U is outputted from the priority order decision part 23. The interrupt signal U is inputted to the comparator 30, and the comparator 30 compares the priority order which is described in the interrupt level signal Ub with the priority order which is set up in the mask register 31. In case that the priority order which is described in the interrupt level signal Ub is higher than the priority order which is set up in the mask register 31, the interrupt signal U is not masked but inputted to the output parts 24₁ and 24₂. In this time, a value of the mask register 31 is set up as a minimum value (a value of the lowest priority order), accordingly, the interrupt signal U is not masked. Afterwards, the handling which is similar to the above description is performed in the output parts 24₁ and 24₂, and at the time t3, the interrupt signals T₁ and T₂ are outputted from the comparators 26₁ and 26₂, respectively.

In the same manner as the above description, the processor 2₁ is assumed to accept the interrupt signal T₁ at the time t4. Hereupon, the processor 2₁ starts the action of the interrupt handling routine and changes the value of the mask register 31 into a maximum value (a value of the highest priority order). Hereby, the interrupt signal U is cancelled. Thus, at the time t4, the interrupt flag signal Ua and the interrupt level signal Ub are cleared. According to this, the interrupt signal T₁ and T₂ are also cleared. The processor 2₁ returns the value of the mask register 31 to the minimum value when ending the interrupt handling routine. Hereby, the cancel of the interrupt signal U is appropriately released. Besides, at the time t5, the processor 2₁ clears the interrupt request S.

In such a manner, by means of the multiprocessor system according to the present preferred embodiment 1, in case that the interrupt request S is inputted to the interrupt controller 5, the interrupt controller 5 inputs the interrupt signal T to all of the processors 2₁ to 2ₙ. Then, when the interrupt request S is accepted by one of the processors 2₁ to 2ₙ, the interrupt controller 5 cancels the interrupt signal T by changing the value of the mask register 31 into the maximum value. As a result, the situation can be avoided that after the interrupt request S is accepted by one of the processors 2₁ to 2ₙ, the same interrupt request S is again accepted by the other processors 2₁ to 2ₙ.

Preferred Embodiment 2.

With regard to the multiprocessor system according to the preferred embodiment 1 described above, the problem that the plural processors 2₁ and 2₂ perform the interrupt handling corresponding with one interrupt signal U is solved by means of adding the comparator 30 and the mask register 31. In the present preferred embodiment 2, a multiprocessor system which solves this problem by the other method is described.

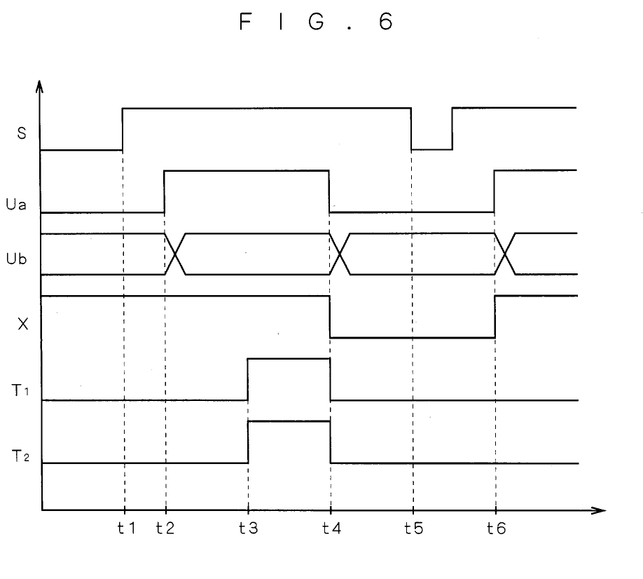

A formation of the interrupt controller according to the present preferred embodiment 2 is similar to the formation shown in FIG. 2. FIG. 6 is a timing chart for describing an action of the interrupt controller according to the present preferred embodiment 2. Referring to FIGS. 1, 2 and 6, the action of the interrupt controller according to the present preferred embodiment 2 is described hereinafter.

In the same manner as the above description, at the time t1, the interrupt request S is inputted to the interrupt request register 21. In this time, the permission bit of the interrupt request register 21(“X” in FIG. 6) is set up as “permission” (=“H”). Then, after the decision of the priority order is performed by the priority order decision parts 22 and 23, at the time t2, the interrupt signal U is outputted from the priority order decision part 23. Afterwards, the handling which is similar to the above description is performed in the output parts 24₁ and 24₂, and at the time t3, the interrupt signals T₁ and T₂ are outputted from the comparators 26₁ and 26₂, respectively.

In the same manner as the above description, at the time t4, the processor 2₁ is assumed to accept the interrupt signal T₁. Then, the processor 2₁ starts performing the interrupt handling routine. Besides, in order to analyze the interrupt factor, the processor 2₁ has access to the interrupt controller 5, and performs the read-out of the contents of the register and so on in the interrupt controller 5. In response to the signal which is inputted from the processor 2₁ by reason of the access, the interrupt controller 5 changes the permission bit X into “non-permission” (=“L”). Hereby, the interrupt signal U is cancelled. That is, at the time t4, the interrupt flag signal Ua and the interrupt level signal Ub are cleared. According to this, the interrupt signals T₁ and T₂ are also cleared. At the time t6, when ending the interrupt handling routine, the processor 2₁ returns the permission bit X to “permission”. Hereby, the cancel of the interrupt signal U is appropriately released. Besides, at the time t₅, the processor 2₁ clears the interrupt request S.

In such a manner, by means of the multiprocessor system according to the present preferred embodiment 2, in case that the interrupt request S is inputted to the interrupt controller 5, the interrupt controller 5 inputs the interrupt signal T to all of the processors 2₁ to 2ₙ. Then, when the interrupt request S is accepted by one of the processors 2₁ to 2ₙ, the interrupt controller 5 cancels the interrupt signal T by setting up the permission bit X as “non-permission”. As a result, the situation can be avoided that after the interrupt request S is accepted by one of the processors 2₁ to 2ₙ, the same interrupt request S is again accepted by the other processors 2₁ to 2ₙ.

Moreover, adding the comparator 30 and the mask register 31 is unnecessary, therefore, the formation of the device can be simplified as compared with the multiprocessor system according to the preferred embodiment 1 described above.

While the invention has been shown and described in detail, the foregoing description is in all aspects illustrative and not restrictive. It is therefore understood that numerous modifications and variations can be devised without departing from the scope of the invention.

What is claimed is:

1. A multiprocessor system, comprising:
plural processors; and
an interrupt controller which is connected with said plural processors,
in case that an interrupt request is inputted to said interrupt controller, said interrupt controller inputs an interrupt signal to said plural processors, and
when said interrupt request is accepted by one of said plural processors, a processor which accepts said interrupt request makes said interrupt controller cancel said interrupt signal.

2. The multiprocessor system according to claim 1, wherein said interrupt controller has
a mask register in which a priority level is set up; and
a comparator which compares a priority level of said interrupt signal with the priority level which is set up in said mask register, wherein
both are shared with said plural processors,
as a result of a comparison by said comparator, in case that the priority level of said interrupt signal is higher than the priority level which is set up in said mask register, said interrupt controller inputs said interrupt signal to said plural processors, and
when said interrupt request is accepted by one of said plural processors, said processor which accepts said interrupt request changes the priority level which is set up in said mask register into a maximum value.

3. The multiprocessor system according to claim 2, wherein said processor which accepts said interrupt request changes the priority level which is set up in said mask register into a minimum value when ending an interrupt handling.

4. The multiprocessor system according to claim 1, wherein said interrupt controller has a register which sets up a permission or non-permission of an acceptance of said interrupt request from an outside,
said interrupt controller inputs said interrupt signal to said plural processors under a condition that said register is set up as “permission”, and
when said interrupt request is accepted by one of said plural processors, said interrupt controller sets up said register as “non-permission” based on a signal from said processor which accepts said interrupt request.

5. The multiprocessor system according to claim 4, wherein said processor which accepts said interrupt request sets up said register as “permission” when ending the interrupt handling.
